(19) United States
(12) Patent Application Publication
(10) Pub. No.: US 2011/0086649 A1
(43) Pub. Date: Apr. 14, 2011

(54) Methodology for Traffic Control Based on Cross-Carriers Short Message (SMS) Application

(75) Inventors: FENG XU, Nanjing (CN); ZHUGUO ZHANG, Nanjing (CN); ZHIGANG XU, Nanjing (CN); HAIDONG PANG, Nanjing (CN); ZHIQIANG LU, Nanjing (CN); JIANGUO REN, Nanjing (CN); WEI WANG, Nanjing (CN)

(73) Assignee: LINKAGE TECHNOLOGY GROUP CO., LTD., Nanjing (CN)

(21) Appl. No.: 12/901,750

(22) Filed: Oct. 11, 2010

(30) Foreign Application Priority Data
Oct. 12, 2009 (CN) 200910035859.5

(51) Int. Cl. H04W 4/12

(52) U.S. Cl. 455/466

(57) ABSTRACT

Method of traffic control for cross-carrier SMS application, the major feature is to set different RAM realization strategies and achieve traffic control over the operational process of SMS by setting different limits for different carriers including the overall limit, total traffic limit and individual user's traffic limit; 1) Different carriers adopt different overall limits: traffic limit is set for different carriers in RAM, based on differences of the receiving number's properties. 2) Overall Traffic Limit: It is achieved by setting a simple overall traffic limit. When the time limit is reached for sending the message, all sending modules will temporarily suspend the sending procedure for a certain time until the defined time. 3) The strategy of using RAM to restrict individual user's network traffic: RAM can be achieved through HASH MAP. 4) The implementation of RAM strategy: using RAM in accordance with different traffic control requirements. 5) In order to achieve “time-out processing”, the system also add the “time-out sub thread”. Through this thread, the message will be transferred to the “time-out processing module” automatically in the case of timeout.

### FIELD OF THE INVENTION

This invention relates to applications for telecom carrier SMS traffic control models and methods.

### BACKGROUND GROUND OF THE INVENTION

Telecom carriers have developed SMS agreement for SMS applications, including China Mobile Peer to Peer (CMPP), China Telecom Short Message Gateway Protocol (SMGP), and China Unicom Short Message Gateway Interface Protocol (SGIP), all of which are based on the international standard Short message peer to peer (SMPP) protocol, and the carriers make some changes on the agreement in accordance with different requirements. These protocols specify and define the method of connection between various network elements and connection protocols within each carrier's SMS service. The interface definition specifies each network element's achievement for various business functions, which is also the technical basis for the carrier or Service Provider (SP) to provide SMS service.

The SMS communication between different carriers is achieved by interoperability gateway. The competition between different carriers makes the carriers set restrictions on interoperability gateway for sending text messages to different network users, mainly in the same numbers. The time interval between test messages is 12-18 seconds; if less than the said time, the receiver interoperability gateway will put the number on the blacklist and the message is no longer sent down. Once on the blacklist, the number can only be removed from the blacklist through automatic removal (after 12-24 hrs) or manual removal, which seriously affects the calling side's message sending.

Neither the standard SMPP protocol nor each carrier's own agreement has defined the function and requirement for traffic control. Therefore, everything that are developed based on these protocols, including interoperability gateway, SMS center, and SMS service gateway which are developed based on these protocols were unable to achieve the function of traffic control. The can only downlink the message at a fixed rate which means downlink message cannot in accordance with caller ID and different called side's situation to carry out flow control.

### SUMMARY OF THE INVENTION

The purpose of the invention is to provide a method for traffic control based on cross-carrier SMS application, and thereby achieve traffic control to ensure that all sent SMS no longer on the blacklist.

The technical solution of this invention is as follows: based on the method of traffic control for cross-carrier SMS application, the invention is to achieve the traffic control in the SMS service gateway by using memory databases, message queues, threading, and SMS gateway in accordance with the different overall limit, overall traffic limit and individual user's traffic limit of carriers. Then, the traffic control over the information transaction during the message sending process could be achieved by setting different Random Access Memory (RAM) implementation strategies.

Method of traffic control for cross-carrier SMS application, the major feature is to set different RAM realization strategies and achieve traffic control over the operational process of SMS by setting different limits for different carriers including the overall limit, total traffic limit and individual user's traffic limit

1) Different carriers adopt different overall limits: traffic limit is set for different carriers in RAM, based on differences of the receiving number's properties. These properties include current time, last calling time, the number of text messages that have been sent, and the maximum allowable number of text messages. Software will calculate the traffic time for each message. If it reaches the time limit, the system will automatically transfer the message to “over-time processing module”.

2) Overall Traffic Limit: It is achieved by setting a simple overall traffic limit. When the time limit is reached for sending the message, all sending modules will temporarily suspend the sending procedure for a certain time (e.g. 1 second) until the defined time.

3) The strategy of using RAM to restrict individual user's network traffic: RAM can be achieved through HASH MAP. Setting a HASH MAP for each carrier could create a HASH MAP record for each carrier when a new “sending number” appears. For each outgoing message, the system records the statistics for sending this message from the sending number to a service carrier. Again, if the time limit is reached for sending the message, it will be transferred to “time-out processing module”. The advantage of using the HASH MAP is that even when traffic volume is high, it does not incur query cost and ensures the running speed of the software. The disadvantage of using the HASH MAP is the large usage of RAM. Through calculation, the RAM usage reaches about 1 G after running a certain time. This problem has been solved after adding automatic calculation and clean-up function;

4) The implementation of RAM strategy: using RAM in accordance with different traffic control requirements. The whole process uses a number of array (LIST) queue. The “normal sending queue” is used for “normal sending”, the “delay sending queue” is used for “time-out processing” and the “send failed queue” is used for “send failed processing”.

5) In order to achieve “time-out processing”, the system also add the “time-out sub thread”. Through this thread, the message will be transferred to the “time-out processing module” automatically in the case of timeout.

Different carriers adopt different overall traffic limit: these are mainly based on differences of the receive number's properties. These properties include the information of the current time, last calling time, the current number of SMS has been sent, and the maximum allowable number of SMS. Software will calculate each traffic for each message. If it reaches to the time limit, the system will automatically transfer it to “time-out processing module”.

Overall Traffic Restriction: It is achieved by setting a simple overall traffic limit. When the SMS reaches the time limit, all sending modules will temporarily “suspend sending” for a certain time (e.g. 1 second) to a defined time.

The strategy of using RAM to restrict individual user's network traffic: RAM can be realized through HASH MAP. Setting a HASH MAP for each carrier could create a HASH MAP record for each carrier when a new “sending number” appears. For each outgoing message, the system could determine the statistical condition of current send record for “sending number” to “a carrier”. Again, if the SMS reaches to the time limit, it will be transferred to “time-out processing module”. The advantage of using the HASH MAP is even under the high traffic volume; it won't bring much query cost and meanwhile ensures the running speed of the software. The disadvantage of using the HASH MAP is the usage of RAM is quite large. Through calculation, the RAM usage reaches about 1 G after running a certain time. This problem has been solved after adding automatic calculation and clean-up function.

The implementation of RAM strategy which uses RAM differently has solved different traffic control requirements. The whole process uses a number of array (LIST) queue. The “normal sending queue” is used for “normal sending”, the “delay sending queue” is used for “time-out processing” and the “send failed queue” is used for “send failed processing”.

In order to achieve “time-out processing”, the system also add the “time-out sub thread”. Through this thread, the system will be transferred to the “time-out processing module” automatically in the case of timeout.

The invention is designed in accordance with the requirements: different carriers has different overall traffic limit+overall traffic limit+individual user's traffic limit, set a different RAM implementation strategy.

The beneficial effect of the invention: This invention fully realized the network traffic speed control which successfully avoids “blacklist” when sending SMS.

### BRIEF DESCRIPTION OF THE DRAWINGS

The following diagram and flow chart are used for a further illustration of this invention.

FIG. 1 is overall framework of the invention process (software) system,

FIG. 2 is the major code of the design which relies on the central dispatching thread and the corresponding of RAM design.

FIG. 3 shows the major code of this invention's speed setting rate.

### DETAIL DESCRIPTION OF THE INVENTION

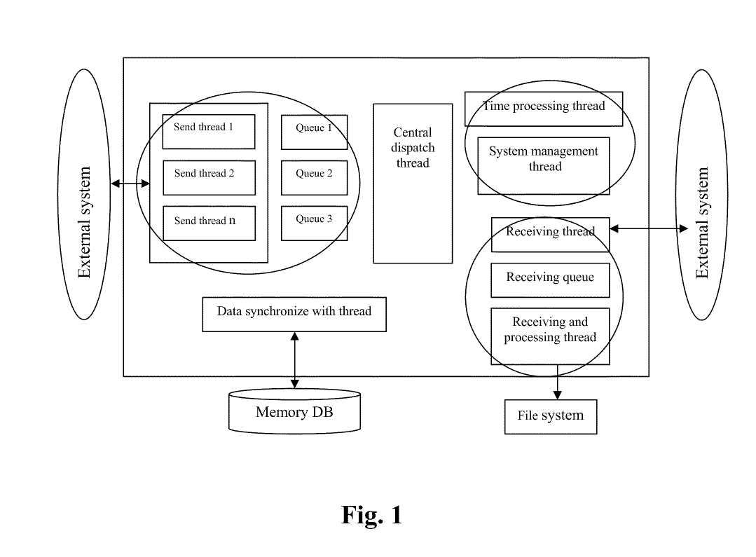

FIG. 1 shows the framework of whole software system, this invention is located in the “central dispatching thread”. The whole automatic management system over the corresponding tread is operated based on the parameters of region and number of carriers and so on. Data synchronization can also be directly connected with the database framework.

The invention has already implemented in Jiangsu Telecom and has been running normally for more than two years. This system is mainly relied on the Linux machines with 4 G Memory and CPU 1.4 G MHz. It has been installed on three machines and designed for the requirements of different carriers' operations.

The system is mainly depending on central dispatching thread and the corresponding RAM design, and the relevant section of the main code is the following:

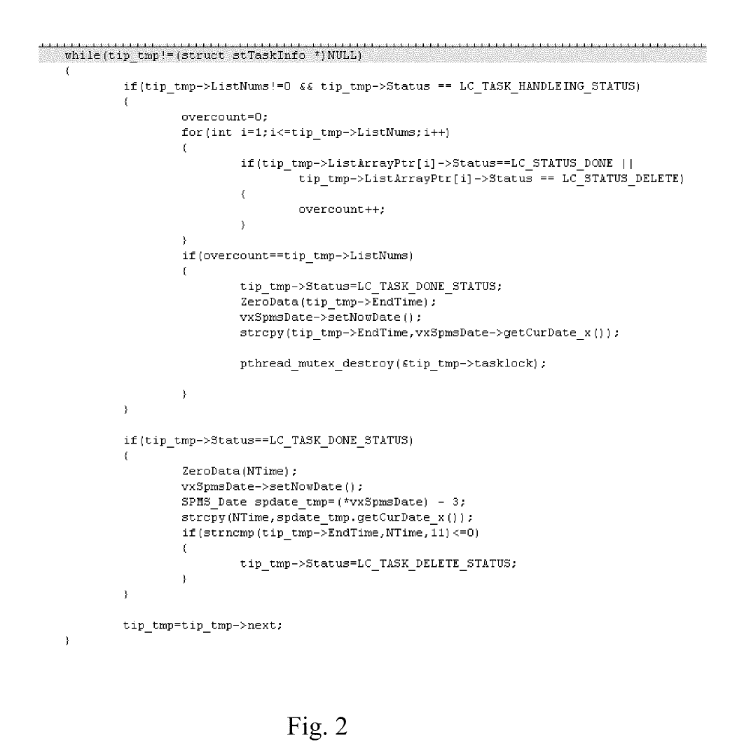

FIG. 2 is the major code of the design which relies on the central dispatching thread and the corresponding of RAM design.

The system distinguishes each carrier's traffic limit by sorting the properties of “receiving number” (Number of Number Section): The traffic limit of China Mobile's individual user is 12 seconds per text message, and the traffic limit of China Unicom's individual user is 4 seconds per text message. Based on this restriction, the system will count the traffic for each user and each message, and overtime message will be transferred to “time-out processing module”.

The current setting for the general traffic control is 200 messages per second. When the overtime was found, all sending modules will be suspended, for example: if it has already completed sending 200 messages within 1/2 seconds, it will suspend for 1/2 seconds then continue sending.

The term “overtime” actually is based on specification of each speed limit, before the specified time (1 second, or 12 second for each user) arrives, if it has completed sending for the number of strokes, all of the following SMS are called “overtime SMS”.

The whole operational process of array (LIST) procedure: The “normal sending queue” used the “first in first-out” approach. The “send failed queue” refers to the failure of sending messages that is caused by the abnormal of TCP connection and transferred to a queue, and then process by a separate processing thread later; Once “normal sending procedure” detect the “overtime” status, the overtime SMS will be transferred into this array and then processed through an individual processing thread that scan and detect the whole array to ensure whether each data has arrived the “transferrable” time. If so, the system will transfer this SMS to the “delayed sending queue” into the “normal sending queue”.

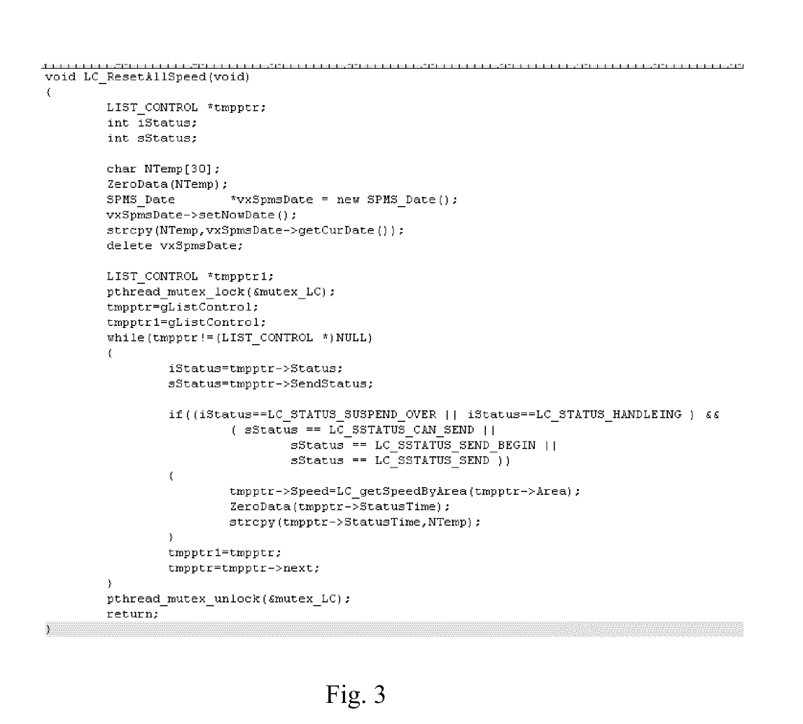

FIG. 3 shows the major code of this invention's speed setting rate.

The invention is based on business operations with different scenarios and combined with using RAM differently, and solves a complex issue which three network SMS traffic control completely and maintains the processing speed of the system.

What is claimed is:

1. Method of traffic control for cross-carrier SMS application, the major feature is to set different RAM realization strategies and achieve traffic control over the operational process of SMS by setting different limits for different carriers including the overall limit, total traffic limit and individual user's traffic limit
1) Different carriers adopt different overall limits: traffic limit is set for different carriers in RAM, based on differences of the receiving number's properties. These properties include current time, last calling time, the number of text messages that have been sent, and the maximum allowable number of text messages. Software will calculate the traffic time for each message. If it reaches the time limit, the system will automatically transfer the message to “over-time processing module”.
2) Overall Traffic Limit: It is achieved by setting a simple overall traffic limit. When the time limit is reached for sending the message, all sending modules will temporarily suspend the sending procedure for a certain time (e.g. 1 second) until the defined time.
3) The strategy of using RAM to restrict individual user's network traffic: RAM can be achieved through HASH MAP. Setting a HASH MAP for each carrier could create a HASH MAP record for each carrier when a new “sending number” appears. For each outgoing message, the system records the statistics for sending this message from the sending number to a service carrier. Again, if the time limit is reached for sending the message, it will be transferred to “time-out processing module”. The advantage of using the HASH MAP is that even when traffic volume is high, it does not incur query cost and ensures the running speed of the software. The disadvantage of using the HASH MAP is the large usage of RAM. Through calculation, the RAM usage reaches about 1 G after running a certain time. This problem has been solved after adding automatic calculation and clean-up function;
4) The implementation of RAM strategy: using RAM in accordance with different traffic control requirements. The whole process uses a number of array (LIST) queue. The “normal sending queue” is used for “normal sending”, the “delay sending queue” is used for “time-out processing” and the “send failed queue” is used for “send failed processing”.
5) In order to achieve “time-out processing”, the system also add the “time-out sub thread”. Through this thread, the message will be transferred to the “time-out processing module” automatically in the case of timeout.
